(19) United States
(12) Patent Application Publication
(10) Pub. No.: US 2017/0106788 A1
(43) Pub. Date: Apr. 20, 2017

(54) Collapsible Illuminated Roadside Hazard Warning Device

(71) Applicant: Roger Garcia, Brookyln, NY (US)

(72) Inventor: Roger Garcia, Brookyln, NY (US)

(21) Appl. No.: 14/882,690

(22) Filed: Oct. 14, 2015

(51) Int. Cl. B60Q 7/00; F21V 23/04; F21V 23/06; F21L 4/08; F21V 21/26

(52) U.S. Cl. CPC B60Q 7/00; F21L 4/08; F21V 21/26; F21V 23/06; F21V 23/04; F21V 23/0407; F21Y 2101/02; F21Y 2103/003

(57) ABSTRACT

A collapsible, illuminated roadside hazard warning device for illuminated roadside hazard warning includes a base that has a housing. A power module is coupled to and positioned in the housing. A crossbar is pivotally coupled to a front of the housing. Each of a pair of sidebars has a first end and a second end, the first ends being pivotally coupled to a respective one of opposing ends of the crossbar. The second ends of the pair of sidebars are reversibly couplable to one another. A plurality of lights is arrayed in and coupled to the crossbar and the pair of sidebars. The lights are operationally coupled to the power module.

### BACKGROUND OF THE DISCLOSURE

### Field of the Disclosure

The disclosure relates to hazard warning device s and more particularly pertains to a new hazard warning device for illuminated roadside hazard warning.

### SUMMARY OF THE DISCLOSURE

An embodiment of the disclosure meets the needs presented above by generally comprising a base that has a housing. A power module is coupled to and positioned in the housing. A crossbar is pivotally coupled to a front of the housing. Each of a pair of sidebars has a first end and a second end, the first ends being pivotally coupled to a respective one of opposing ends of the crossbar. The second ends of the pair of sidebars are reversibly couplable to one another. A plurality of lights is arrayed in and coupled to the crossbar and the pair of sidebars. The lights are operationally coupled to the power module.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric view of a collapsible, illuminated roadside hazard warning device according to an embodiment of the disclosure.

FIG. 2 is a top view of an embodiment of the disclosure.

FIG. 3 is a front view of an embodiment of the disclosure.

FIG. 4 is a back view of an embodiment of the disclosure.

FIG. 5 is a detail cut-away view of an embodiment of the disclosure.

### DESCRIPTION OF THE PREFERRED EMBODIMENT

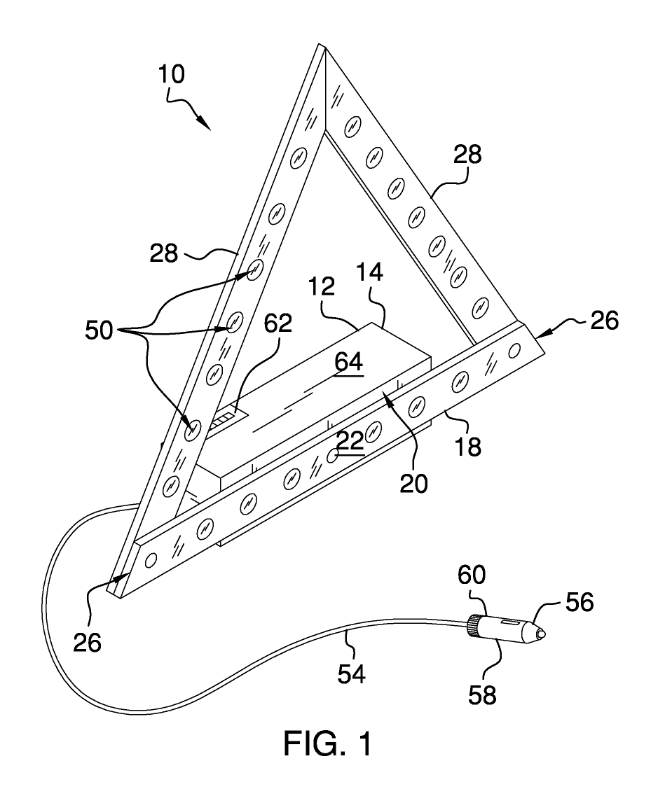

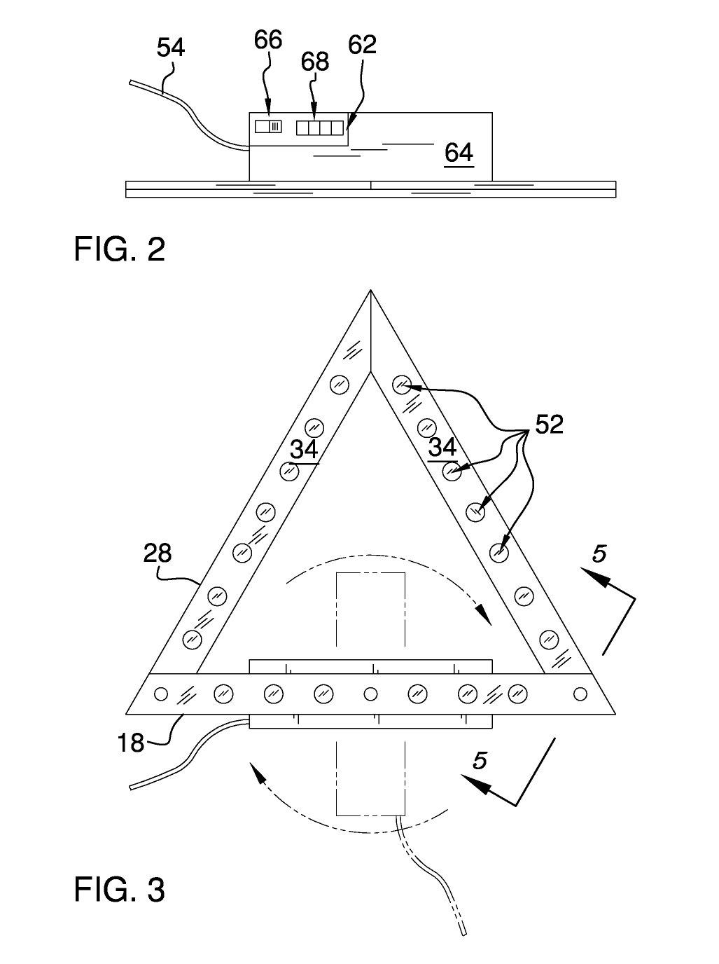

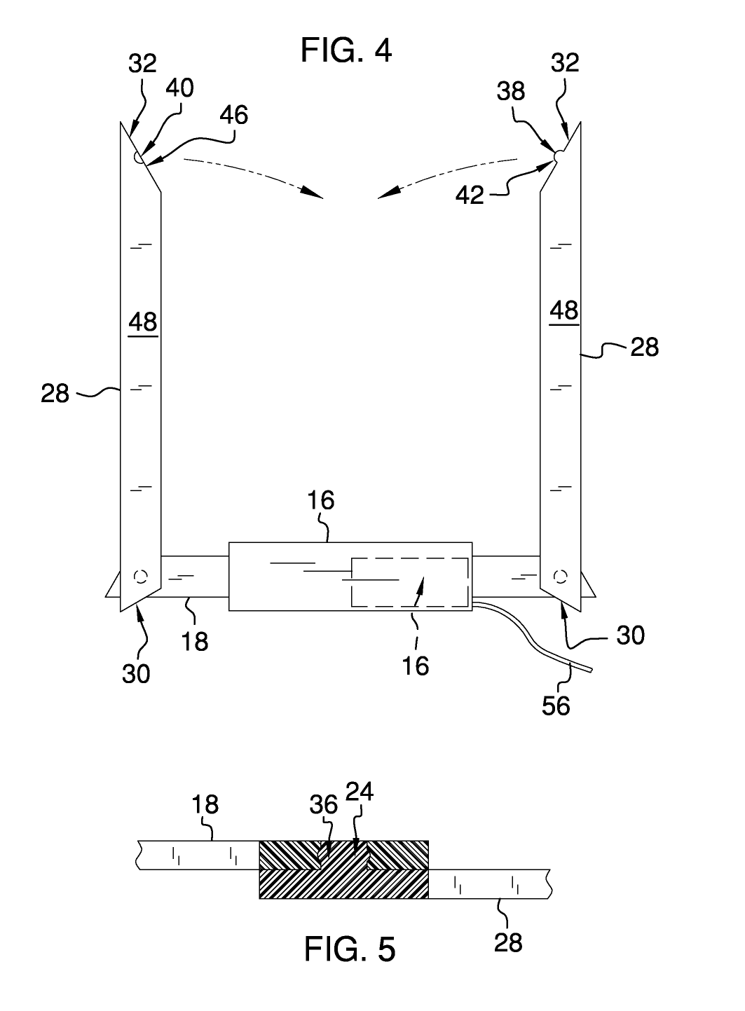

With reference now to the drawings, and in particular to FIGS. 1 through 5 thereof, a new hazard warning device embodying the principles and concepts of an embodiment of the disclosure and generally designated by the reference numeral 10 will be described.

As best illustrated in FIGS. 1 through 5, the collapsible, illuminated roadside hazard warning device 10 generally comprises a base 12 that has a housing 14. A power module 16 is coupled to and positioned in the housing 14. The power module 16 comprises at least one rechargeable battery. A crossbar 18 is pivotally coupled to a front 20 of the housing 14. The crossbar 18 is reflective. The crossbar 18 has a front face 22 that is reflective. Each of a pair of concavities 24 is positioned proximate to a respective one of opposing ends 26 of the crossbar 18. The opposing ends 26 are angular. Each of a pair of sidebars 28 has a first end 30 and a second end 32. The first ends 30 are pivotally coupled to a respective one of the opposing ends 26 of the crossbar 18. The second ends 32 are reversibly couplable. The sidebars 28 are reflective. The sidebars 28 have a front surface 34 that is reflective. The first ends 30 and the second ends 32 are angular. Each of the sidebars 28 has a protrusion 36 positioned proximate to a respective one of the first ends 30. The protrusions 36 are complimentary to the concavities 24, such that the concavities 24 are positioned to accept the protrusions 36 to pivotally couple the sidebars 28 to the crossbar 18. The device 10 includes a first coupler 38 that is complimentary to a second coupler 40, the couplers 38 and 40 being coupled to a respective one of the second ends 32. The first coupler 38 comprises a tab 42 that extends from a back face 44 at the second end 32 of a first one of the pair of sidebars 28. The second coupler 40 comprises a circular indentation 46 in a back surface 48 of a second one of the pair of sidebars 28 proximate to the second end 32. The first coupler 38 is positioned to reversibly couple with the second coupler 40, such that the crossbar 18 and the pair of sidebars 28 form a triangular shape. A plurality of lights 50 is arrayed in and coupled to the crossbar 18 and the pair of sidebars 28. The lights 50 are operationally coupled to the power module 16. The plurality of lights 50 is embedded in the front face 22 of the crossbar 18 and the front surfaces 34 of the sidebars 28. The lights 50 comprise light emitting diodes 52. The plurality of lights 50 comprises seven lights coupled to each of the sidebars 28 and six lights coupled to the crossbar 18. A charging cable 54 is operationally coupled to the power module 16. The cable 54 has a free end 56 that comprises a coupler 58, such that the coupler 58 is couplable to a power source to recharge the power module 16. Preferably, the free end 56 comprises a 12 volt accessory outlet plug 60. A control panel 62 is coupled to and positioned in a top 64 of the housing 14. The control panel 62 is operationally coupled to the plurality of lights 50 and the power module 16. The control panel 62 comprises an on/off switch 66 and a selector 68, such that the selector 68 determines flashing sequences for the plurality of lights 50.

In use, the device 10 is readily deployable in an emergency situation by pivoting the sidebars 28 relative to the crossbar 18, engaging the first coupler 38 to the second coupler 40 to form a triangular shape, and using the control panel 62 to select an appropriate lighting sequence for the plurality of lights 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A collapsible, illuminated roadside hazard warning device comprising:
a base, said base having a housing;
a power module, said power module being coupled to and positioned in said housing;
a crossbar, said crossbar being pivotally coupled to a front of said housing;
a pair of sidebars, each of said sidebars having a first end and a second end, said first ends being pivotally coupled to a respective one of said opposing ends of said crossbar, said second ends of said pair of sidebars being reversibly couplable; and
a plurality of lights, said lights being arrayed in and coupled to said crossbar and said pair of sidebars, said lights being operationally coupled to said power module.

2. The device of claim 1, further including a charging cable, said cable being operationally coupled to said power module, said cable having a free end, said free end comprising a coupler, wherein said coupler is couplable to a power source for recharging said power module.

3. The device of claim 2, further including said free end comprising a 12 volt accessory outlet plug.

4. The device of claim 1, further including a control panel, said control panel being coupled to and positioned in a top of said housing, said control panel being operationally coupled to said plurality of lights and said power module, said control panel comprising an on/off switch.

5. The device of claim 1, further including said control panel comprising a selector, wherein said selector determines flashing sequences for said plurality of lights.

6. The device of claim 1, further including said power module comprising at least one rechargeable battery.

7. The device of claim 1, further including said crossbar and said sidebars being reflective.

8. The device of claim 1, further comprising:
said cross bar having a front face, said front face being reflective; and
said sidebars having a front surface, said front surface being reflective.

9. The device of claim 1, further comprising:
said crossbar having a pair of concavities, each of said concavities being positioned proximate to a respective one of opposing ends of said crossbar; and
each of said sidebars having a protrusion positioned proximate to a respective one of said first ends, said protrusions being complimentary to said concavities, wherein said concavities are positioned to accept said protrusions to pivotally couple said sidebars to said crossbar.

10. The device of claim 1, further said opposing ends, said first ends and said second ends being angular.

11. The device of claim 1, further including a first coupler and a second coupler, said first coupler being complimentary to said second coupler, each of said couplers being coupled to a respective one of said second ends.

12. The device of claim 11, further comprising:
said first coupler comprising a tab extending from a back face at said second end of a first one of said pair of sidebars;
said second coupler comprising a circular indentation in a back surface of a second one of said pair of sidebars proximate to said second end; and
wherein said first coupler is positioned to reversibly couple with said second coupler, such that said crossbar and said pair of sidebars form a triangular shape.

13. The device of claim 8, further including said plurality of lights being embedded in said front face of said crossbar and said front surfaces of said sidebars.

14. The device of claim 1, further including said lights comprising light emitting diodes.

15. The device of claim 1, further said plurality of lights comprising seven lights coupled to each of said sidebars and six lights coupled to said crossbar.

16. A collapsible, illuminated roadside hazard warning device comprising:
a base, said base having a housing;
a power module, said power module being coupled to and positioned in said housing, said power module comprising at least one rechargeable battery;
a crossbar, said crossbar being pivotally coupled to a front of said housing, said crossbar being reflective, said cross bar having a front face, said front face being reflective, said crossbar having a pair of concavities, each of said concavities being positioned proximate to a respective one of opposing ends of said crossbar, said opposing ends being angular;
a pair of sidebars, each of said sidebars having a first end and a second end, said first ends being pivotally coupled to a respective one of said opposing ends of said crossbar, said second ends of said pair of sidebars being reversibly couplable, said sidebars being reflective, said sidebars having a front surface, said front surface being reflective, said first ends and said second ends being angular, each of said sidebars having a protrusion positioned proximate to a respective one of said first ends, said protrusions being complimentary to said concavities, wherein said concavities are positioned to accept said protrusions to pivotally couple said sidebars to said crossbar;
a first coupler and a second coupler, said first coupler being complimentary to said second coupler, each of said couplers being coupled to a respective one of said second ends, said first coupler comprising a tab extending from a back face at said second end of a first one of said pair of sidebars, said second coupler comprising a circular indentation in a back surface of a second one of said pair of sidebars proximate to said second end, such that said first coupler is positioned to reversibly couple with said second coupler, wherein said crossbar and said pair of sidebars form a triangular shape;
a plurality of lights, said lights being arrayed in and coupled to said crossbar and said pair of sidebars, said lights being operationally coupled to said power module, said plurality of lights being embedded in said front face of said crossbar and said front surfaces of said sidebars, said lights comprising light emitting diodes, said plurality of lights comprising seven lights coupled to each of said sidebars and six lights coupled to said crossbar;
a charging cable, said cable being operationally coupled to said power module, said cable having a free end, said free end comprising a coupler, wherein said coupler is couplable to a power source for recharging said power module, said free end comprising a 12 volt accessory outlet plug;
a control panel, said control panel being coupled to and positioned in a top of said housing, said control panel being operationally coupled to said plurality of lights and said power module, said control panel comprising an on/off switch, said control panel comprising a selector, wherein said selector determines flashing sequences for said plurality of lights; and
wherein said device is readily deployable in an emergency situation by pivoting said sidebars relative to said crossbar, engaging said first coupler to said second coupler to form a triangular shape, and using said control panel to select an appropriate lighting sequence for said plurality of lights.
